(19) United States
(12) Patent Application Publication
(10) Pub. No.: US 2018/0324786 A1
(43) Pub. Date: Nov. 8, 2018

(54) RESOURCE DETERMINATION FOR UPLINK CONTROL CHANNEL FOR WIRELESS NETWORKS

(71) Applicant: NOKIA TECHNOLOGIES OY, Espoo (FI)

(72) Inventors: Kari Hooli, Oulu (FI); Esa Tapani Tiirola, Kempele (FI); Emad Farag, Flanders, NJ (US)

(21) Appl. No.: 15/969,884

(22) Filed: May 3, 2018

Related U.S. Application Data
(60) Provisional application No. 62/502,550, filed on May 5, 2017.

(51) Int. Cl. H04W 72/04

(52) U.S. Cl. CPC H04W 72/0413

(57) ABSTRACT

A technique includes determining, by a user device, a set of uplink control channel resources out of a plurality of predetermined sets of uplink control channel resources, before the user device has received a user device-specific configuration of uplink control channel resources; selecting, by the user device, an uplink control channel resource of the determined set of uplink control channel resources; and transmitting, by the user device, control information via the selected uplink control channel resource.

### PRIORITY CLAIM

This application claims priority to and the benefit of U.S. Provisional Application No. 62/502,550, filed May 5, 2017, entitled, “RESOURCE DETERMINATION FOR UPLINK CONTROL CHANNEL FOR WIRELESS NETWORKS,” which is incorporated herein by reference in its entirety.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the Long Term Evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

5G New Radio (NR) development is part of a continued mobile broadband evolution process to meet the requirements of 5G, similar to earlier evolution of 3G & 4G wireless networks. A goal of 5G is to provide significant improvement in wireless performance, which may include new levels of data rate, latency, reliability, and security. 5G NR may also scale to efficiently connect the massive Internet of Things (IoT), and may offer new types of mission-critical services.

### SUMMARY

According to an example implementation, a method includes determining, by a user device, a set of uplink control channel resources out of a plurality of predetermined sets of uplink control channel resources, before the user device has received a user device-specific configuration of uplink control channel resources; selecting, by the user device, an uplink control channel resource of the determined set of uplink control channel resources; and transmitting, by the user device, control information via the selected uplink control channel resource.

According to an example implementation, an apparatus includes at least one processor and at least one memory including computer instructions, when executed by the at least one processor, cause the apparatus to: determine, by a user device, a set of uplink control channel resources out of a plurality of predetermined sets of uplink control channel resources, before the user device has received a user device-specific configuration of uplink control channel resources; select, by the user device, an uplink control channel resource of the determined set of uplink control channel resources; and transmit, by the user device, control information via the selected uplink control channel resource.

According to an example implementation, an apparatus includes means for determining, by a user device, a set of uplink control channel resources out of a plurality of predetermined sets of uplink control channel resources, before the user device has received a user device-specific configuration of uplink control channel resources; means for selecting, by the user device, an uplink control channel resource of the determined set of uplink control channel resources; and means for transmitting, by the user device, control information via the selected uplink control channel resource.

According to an example implementation, a computer program product includes a computer-readable storage medium and storing executable code that, when executed by at least one data processing apparatus, is configured to cause the at least one data processing apparatus to perform a method including: determining, by a user device, a set of uplink control channel resources out of a plurality of predetermined sets of uplink control channel resources, before the user device has received a user device-specific configuration of uplink control channel resources; selecting, by the user device, an uplink control channel resource of the determined set of uplink control channel resources; and transmitting, by the user device, control information via the selected uplink control channel resource.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating some slot types according to an example implementation.

FIG. 3A is a diagram illustrating a long physical uplink control channel (PUCCH) format according to an example implementation.

FIG. 3B is a diagram illustrating a short physical uplink control channel (PUCCH) format according to an example implementation, for both one symbol and two symbols.

FIG. 4 is a diagram illustrating example resource sets for a short PUCCH according to an example implementation.

FIG. 5 is a flow chart illustrating operation of a user device according to an example implementation.

FIG. 6 is a block diagram of a node or wireless station (e.g., base station/access point or mobile station/user device) according to an example implementation.

### DETAILED DESCRIPTION

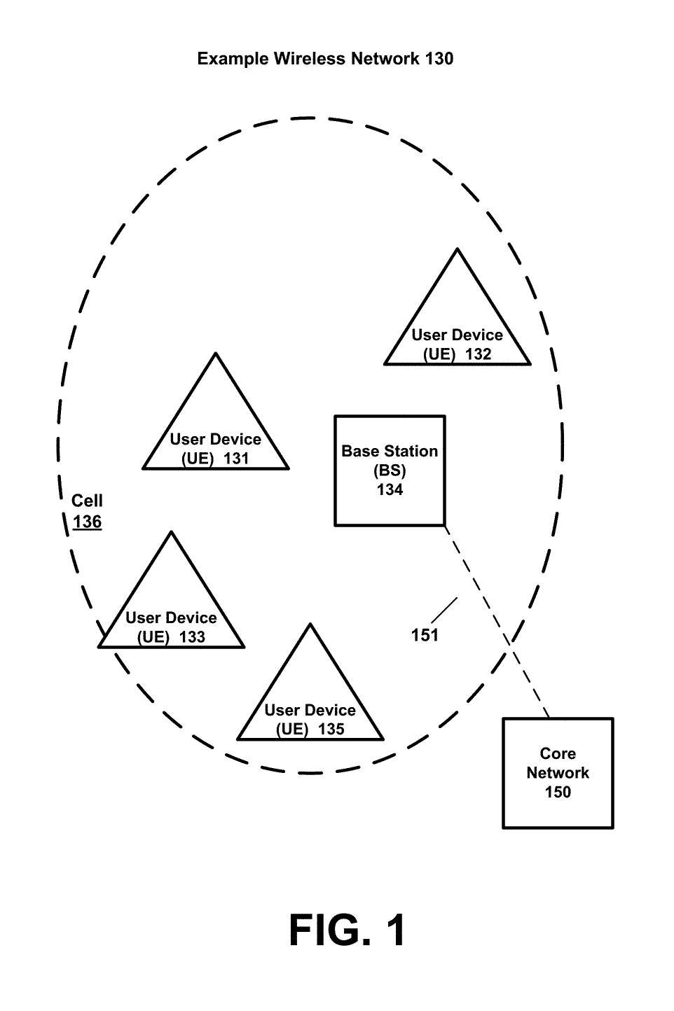

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB, or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a 51 interface 151. This is merely one simple example of a wireless network, and others may be used.

A user device (user terminal, user equipment (UE) or mobile station) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example implementations or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC).

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability, for example, corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability)

The various example implementations may be applied to a wide variety of wireless technologies or wireless networks, such as LTE, LTE-A, 5G, cmWave, and/or mmWave band networks, IoT, MTC, eMTC, eMBB, URLLC, etc., or any other wireless network or wireless technology. These example networks, technologies or data service types are provided only as illustrative examples.

As noted, different data service types (or different types of UEs) may have different performance requirements, such as for reliability (e.g., maximum block error rate), bandwidth or data throughput or minimum data rate, and latency. Some data service types, such as eMBB, may require higher data rates, while tolerating higher block error rates and higher latency (as compared to URLLC). On the other hand, some high reliability data service types, such as URLLC, may require much higher reliability (e.g., lower block error rates) and lower latency, as compared to eMBB. On the other hand, they may operate with relatively small transport blocks sizes (i.e. smaller data throughput) compared to typical eMBB services.

According to an illustrative (and non-limiting) example implementation, a non-high reliability (e.g., eMBB) data service type (or eMBB application) on a UE may, for example, transmit uplink control information via a long physical uplink control channel (PUCCH) (also referred to as a long PUCCH format length), while a high reliability/low latency (e.g., URLLC) data service type (or URLLC application) on the UE may, for example, transmit uplink control information via a short physical uplink control channel (PUCCH) (which may also be referred to as a short PUCCH format length), e.g., to allow for quicker or more frequent transmission of control information. Although, in general, any application may use either long PUCCH or short PUCCH. Thus, in some example cases, a long PUCCH (or long PUCCH format) may be used to allow more data/control information to be sent over a period of time (e.g., for eMBB data service type), while a short PUCCH (or short PUCCH format) may be used to allow for a quicker transmission of uplink control information in the case where a shorter latency (e.g., such as for transmission of HARQ feedback) may be required (such as for URLLC data service type). Although, in another example implementation, the eMBB or non high reliability data service types (such as eMBB and others) may also use a short PUCCH format length.

Uplink control information (UCI), which may be transmitted via PUCCH, may generally include, for example one or more of: hybrid automatic repeat request (HARQ) feedback, e.g., HARQ Acknowledgement/ACK to acknowledge receipt of data, or HARQ negative acknowledgement/NAK to negatively acknowledge data (e.g., indicate that data was not received); scheduling requests (e.g., which may include a request by a UE for an uplink grant of resources to allow the UE to transmit uplink to the BS); and/or channel state information (CSI feedback, which may include, e.g., a rank indication (RI), a precoder matrix indication (PMI), and/or a channel quality indication (CQI)). Also, reference signals, such as demodulation reference signals (DMRS) may also be transmitted by a UE to a BS, and may be used, for example, by a BS to perform channel estimation and then decode received signals or data from the UE.

A situation may arise where a UE may have uplink control information for transmission, but the UE has not yet been assigned a user device-specific configuration of uplink control channel (e.g., PUCCH) resources. Therefore, according to an example implementation, rather than just providing one set of uplink control channel (e.g., PUCCH) resources, which may be quite limited and/or relatively inflexible, a plurality of predetermined sets of uplink control channel resources may be predetermined or known in advance by both the UE and B S/network. And, for example, the UE may determine or select one of these predetermined sets of (e.g., PUCCH) resources from which it will select a (e.g., PUCCH) resource for transmitting uplink control information). According to an example implementation, the UE may then select one resource (or a subset of the resources) within the selected/determined set of uplink control channel (e.g., PUCCH) resources to transmit uplink control information. According to an example implementation, resources may be provided or made available to UEs that may accommodate short PUCCH and long PUCCH.

Thus, according to an example implementation, a technique or method may include determining, by a user device, a set of uplink control channel resources out of a plurality of predetermined sets of uplink control channel resources, before the user device has received a user device-specific configuration of uplink control channel resources; selecting, by the user device, an uplink control channel resource of the determined set of uplink control channel resources; and transmitting, by the user device, control information via the selected uplink control channel resource. For example, the determining a set of uplink control channel resources out of a plurality of predetermined sets of uplink control channel resources may include either (by way of illustrative examples): 1) receiving, during a random access procedure, such as within a random access response (RA message 2) received from a B S, an uplink control channel resource set index that identifies a set of uplink control channel (e.g., PUCCH) resources that the user device/UE should use; or 2) receiving, via a downlink grant or other resource grant, an identifier (e.g., radio network temporary identifier or RNTI) associated with the UE/user device, and then select or determine (e.g., based on the identifier or RNTI, such as two LSBs of the RNTI) a resource set of the plurality of predetermined sets of uplink control channel (e.g., PUCCH) resources, to be used by the user device/UE. A resource within a resource set may be selected for use by a UE for a PUCCH. For example, a UE may receive an acknowledgement resource indicator (ARI) (or other control signal or resource indicator) in a downlink grant or other signal, and the UE may then select a resource of a plurality of resources within the determined or selected uplink control channel resource set. Further example details will now be provided, by way of illustrative examples.

According to an example implementation, in New Radio (NR) (5G) frame structure design, both slot and mini-slot may be supported. The duration of a slot may be either 7 or 14 symbols depending on the subcarrier spacing of the used numerology. Furthermore, slot aggregation may be configured at least for eMBB service. The possible durations of a mini-slot may at least include 1 or 2 OFDM (orthogonal frequency division multiplexing) symbols.

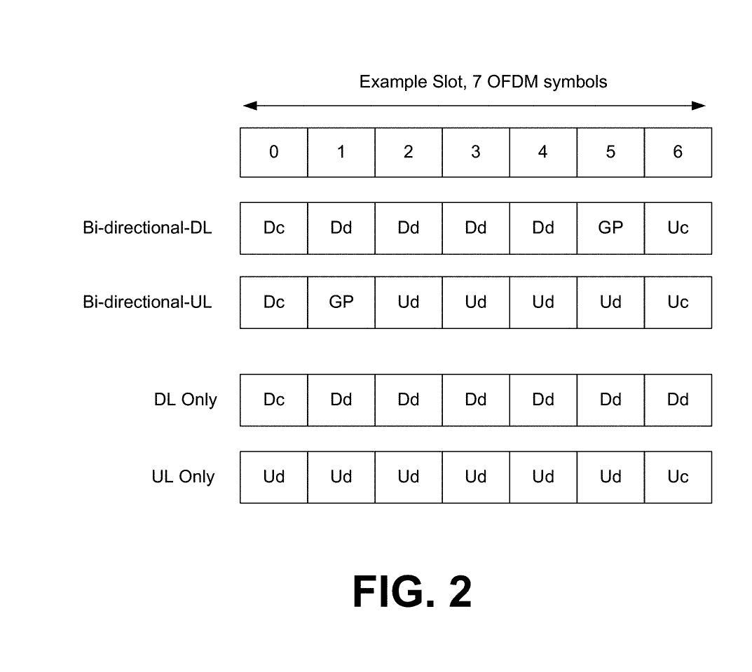

FIG. 2 is a diagram illustrating some slot types according to an example implementation. Symbols are shown for each slot type, with Dc referring to downlink control information, Dd referring to downlink data, GP referring to a guard period, Uc referring to uplink control information, and Ud referring to uplink data. For example, there may be several slot types, as shown in FIG. 2, that provide the basic support for both TDD (time division duplexing) and FDD (frequency division duplexing). For the bi-directional slots, there is either downlink data or uplink data transmission in each slot, as well as the corresponding downlink and uplink control. Bi-directional slot may facilitate many TDD functionalities in the NR frame structure, such as, e.g., link direction switching between DL and UL, fully flexible traffic adaptation between DL and UL, and opportunity for low latency, provided that slot length is selected to be short enough.

In all slots of FIG. 2, multiplexing between DL control, DL/UL data, GP and UL control may be based, for example, primarily on time division multiplexing allowing fast energy efficient pipeline processing of control and data in the receiver. Physical Downlink Control Channel (PDCCH) may be conveyed in the DL control symbol(s) located at the beginning of the slot (or the mini-slot). However, the option of PDCCH and PDSCH multiplexing in frequency domain is not excluded. Additionally, frequency domain multiplexing of long PUCCH and PUSCH may be supported.

In addition to bi-directional slots, there are also DL-only slot and UL-only slot in FIG. 2. These slot types may be needed at least in FDD mode, but also in certain TDD scenarios to allow longer transmission periods in same direction.

According to an example implementation, there can be multiple mini-slots in a slot, and different UEs can be scheduled in different mini-slots. Two main scenarios that benefit from mini-slots are latency reduction and unlicensed band operation. Especially, e.g., when 15 kHz subcarrier spacing is used, mini-slot may provide advantages over slot based transmission. Furthermore, mini-slots may also be a way to provide time multiplexing between different UEs when operating at high carrier frequencies (with higher subcarrier spacing) and when using RF beamforming architecture. Depending on the system operation point (e.g., offered traffic), the use of a mini-slot for lower air interface latency is useful not only for URLLC, but also for some eMBB applications (e.g. for quickly overcoming slow start TCP/transmission control protocol) procedures.

A mini-slot may be used, for example, to support URLLC—with strict delay requirements, which may require small scheduling granularity in time. If a packet is scheduled using a slot, e.g., for HARQ ACK feedback (FB), the delay (between data and HARQ FB for such data) may be 1 or 2 or 3 slots later, for example, which is a substantial delay that may not be tolerated by URLLC. For mini-slots, HARQ FB may be scheduled or transmitted much quicker, e.g., later in same slot that data was received, or in the next slot, which may better accommodate a stringent delay requirements for URLLC, for example.

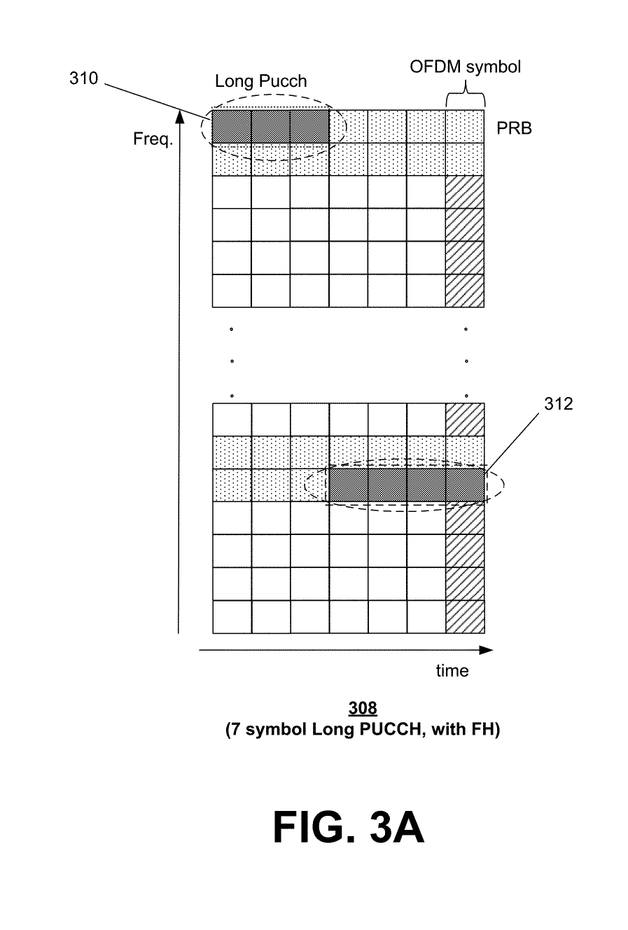

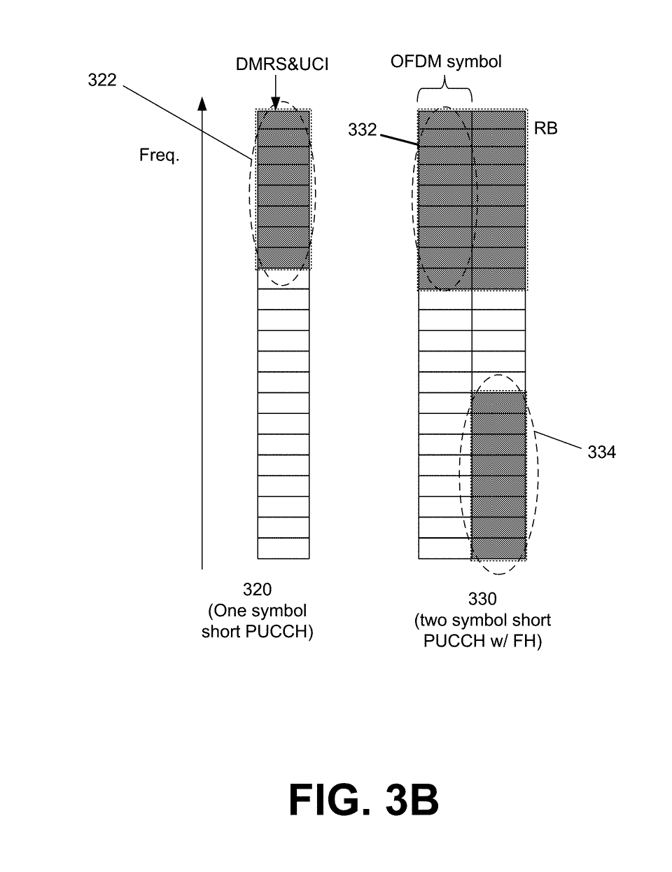

New Radio (NR), or 5G, may support both a short physical uplink control channel (PUCCH), and a long physical uplink control channel. FIG. 3A is a diagram illustrating a long physical uplink control channel (PUCCH) format according to an example implementation. FIG. 3B is a diagram illustrating a short physical uplink control channel (PUCCH) format according to an example implementation, for both one symbol and two symbols.

Referring to FIG. 3A, an example long PUCCH 308 of 7 symbols (e.g., same length as an example slot) is shown, as an illustrative example. Although as noted, a slot may also include 14 symbols, or other number of symbols. Long PUCCH 308 may include, by way of example, a first group 310 of three OFDM symbols of a first physical resource block (RB or PRB, which may include a set of subcarriers), e.g., within the first row, and then a second group 312 of four additional OFDM symbols of a different PRB (e.g., within the ninth row), where each PRB (or physical resource block) may indicate a different frequency or different set of subcarriers, for example. For example, a first symbol of each of the groups 310 and 312 of symbols may include DMRS (e.g., to allow a BS to perform channel estimation and decode received uplink data or information), and the remaining symbols of each group 310 and 312 may include uplink control information such as HARQ feedback, for example. By having a long PUCCH 308 include a group 310 of symbols within a first PRB (the first row) and a group 312 of symbols within another row (e.g., the ninth row), this long PUCCH 308 employs frequency hopping (FH) to provide increased frequency diversity for the long PUCCH format. The long PUCCH shown in FIG. 3A may provide a low PAPR/CM (peak to average power ratio or cubic metric), e.g., when using DFT-S-OFDM based waveform. CP-OFDM may be supported as another waveform option for long PUCCH.

Referring to FIG. 3B, an example short PUCCH 320 of one symbol is shown, as an illustrative example, and may include a group 322 of PRBs within one OFDM symbol. Similarly, a two symbol short PUCCH 330 uses frequency hopping, and may include a first group 332 of PRBs (physical resource blocks) within a first OFDM symbol, and a second group 334 of PRBs within a second OFDM symbol, for example.

A short PUCCH may be optimized to facilitate low latency and it supports also UL control signaling via bi-directional DL slot, for example, and a PUCCH variant that is related to mini-slot may be based on the short PUCCH structure. Frequency domain multiplexing between RS (reference signals, such as demodulation reference signals) and UCI (uplink control confirmation) is supported. Frequency diversity on short PUCCH may be provided based on frequency hopping, clustered transmission or scheduled transmission, depending on the scenario of interest. FDM (frequency division multiplexing) may be provided between UCI and DMRS.

As noted, it is expected that NR (New Radio/5G) will support two variants of PUCCH, including long PUCCH shown FIG. 3A and short PUCCH shown in FIG. 3B. Short PUCCH may be optimized to facilitate low latency and it supports also UL control signaling via bi-directional DL slot. Short PUCCH may occupy 1 or 2 symbols. A PUCCH variant that is related to mini-slot (e.g., 3 symbols) may be based on the short PUCCH structure.

One problem, which may arise, is how a UE determines the PUCCH resource to be used when the UE has not yet received the UE-specific RRC (radio resource control) configuration for the set of PUCCH resources. This information may be needed for random access message 4, for which HARQ-ACK may be transmitted. The one or more example techniques or methods described herein to allow a UE to determine set of uplink control channel (e.g., PUCCH) resources and/or determine an uplink control channel (PUCCH) resource (e.g., before the UE has its UE-specific configuration of PUCCH resource), may include one or more advantages or features, such as, by way of illustrative example: It may be desirable for the way(s) the PUCCH resources are determined to be flexible and efficient, e.g.: It should be possible to indicate PUCCH resources for several simultaneous UEs that do not have configuration of UE-specific dedicated PUCCH resources; PUCCH resources that are used should not unnecessarily fragment UL resources in frequency domain, at least in some cases. In at least some cases, it may be desirable for the solution or technique used by a UE to select PUCCH resource(s) to be compatible with RF (radio frequency) beamforming, e.g., having limited capability to receive multiple parallel PUCCH resources at the same time. For example, the gNB (5G/NR BS) implementation can be based on hybrid beamforming architecture having limited number of TXRUs (transmit/receive units) (which may have a limited number of parallel Rx/receive beams).

According to an example implementation, methods or techniques are provided to allow a UE/user device to determine an uplink control channel (e.g., PUCCH) resource set, e.g., via use of limited signaling overhead. In an example implementation, multiple PUCCH resource sets are predetermined (e.g., these resource sets may be known by both a UE and BS), e.g., in accordance with a specification (or a method to allow UE and BS to determine the predetermined sets of PUCCH resources). For example, there may be an uplink control channel (e.g., PUCCH) resource set index to identify each of the uplink control channel (e.g., PUCCH) resource sets, e.g., resource set indexes=1, 2, 3, 4, etc., to identify different uplink control channel resource sets.

This portion here discusses determining resources within a resource set to be used for PUCCH:

Some Illustrative Characteristics or Qualities of Resource Sets:

Logical PUCCH resource indexes may identify a plurality of resources within a PUCCH resource set. For example, M resources within a PUCCH resource set may be determined, e.g., by of allocation M consecutive PUCCH resources into a same PUCCH resource set. For example, when determining which resources belong to first resource set, M consecutive resources may be assigned/allocated to first resource set, the next set of M consecutive resources for the second set of resources, etc. Also, for example, the value M (number of resources per resource set) and the start of the PUCCH resources (of the predefined uplink control channel resource sets) may be predefined or known for network/BS and UE, or may be communicated or signaled by BS/network to UE.

As an example of such method, first M logical PUCCH resource indexes may comprise first set, second M logical PUCCH resource indexes may comprise second set, etc. Two or more of the (consecutive) resource sets may be partially overlapping. E.g., first set may contain logical PUCCH resource indexes {0, 1, 2, 3} and the second set may contain resource indexes {2, 3, 4, 5}. This may allow for more efficient resource usage, in some cases.

In the case of RF beamforming, it may be beneficial to have also such PUCCH resource sets where different PUCCH resource indexes of a resource set are mapped to different OFDM symbols. For example, with OFDM beam forming, BS may have beam sweeping for control information, where a different beam or set of beams may transmit control information during a different time interval, where each time interval may coincide or overlap with different OFDM symbols, for example. Thus, it may be advantageous to have one or more PUCCH resource sets that have resources that are mapped to different OFDM symbols, for example. For example, one resource set may contain PUCCH resource indexes mapped to the last OFDM symbol of the slot. Another resource set may contain PUCCH resource indexes mapped to a second to last OFDM symbol of the slot. Yet another resource set may contain PUCCH resource indexes mapped to the last and the second to last OFDM symbol of the slot.

In addition, using a PUCCH resource set with multiple OFDM symbols may be useful to facilitate UE-BS communication for UEs that are at a cell edge, or have low received signal strength at a BS. Thus, for example, multiple PUCCH resource sets can be used to boost also the PUCCH coverage for UEs as part of the initial access procedure. This can be performed in such a way that some PUCCH resource sets may contain PUCCH resource indexes containing multiple resources in different OFDM symbols of the slot (or alternatively multiple PUCCH resources in different slots). For example, using a PUCCH resource set with multiple OFDM symbols is compatible with long PUCCH, which may be useful for UE in cell edge location/condition. For example, the PUCCH resource index may contain one PUCCH resource in the last OFDM symbol of the slot and another in the second last OFDM symbol of the slot, respectively.

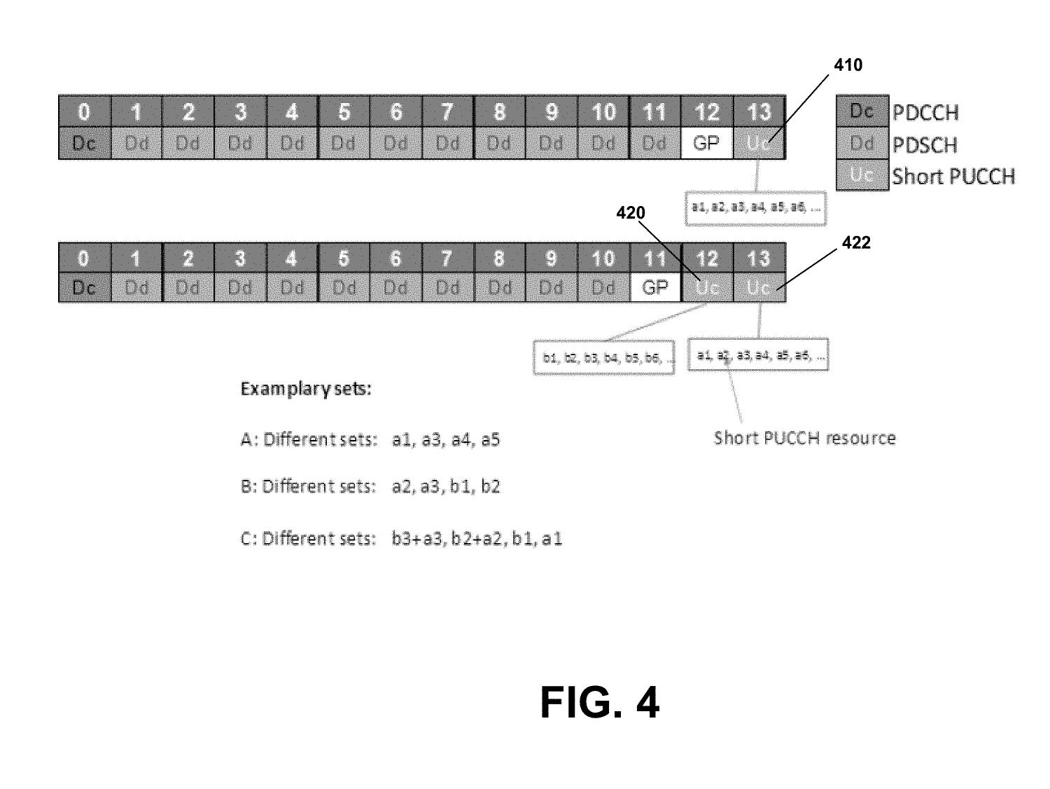

FIG. 4 is a diagram illustrating example resource sets for a short PUCCH according to an example implementation. A number of different OFDM symbols are shown. In a first slot, uplink control information may be transmitted via OFDM symbol 410, and may be used to support a one symbol short PUCCH. Whereas, in a second example slot, uplink control information may be transmitted via OFDM symbols 420 and 422, and may be used to support a two symbol short PUCCH. FIG. 4 illustrates different ways to generate resource sets in a short PUCCH scenario with one or two OFDM symbols allocated to short PUCCH (Uplink control).

### Example A

All resources (a1, a2, a3, a4, a5, a6, a7 . . . ) are located within the last OFDM symbol of the slot. All of the resources (a1, a2, a3, a4, a5, a6 . . . ) are all available resources within last OFDM symbol 410. Different uplink control channel resource sets (A1, A2, A3, . . . ) may be determined or selected based on different subsets of those resources. For example, resource set A1 may contain four predefined resources out of those (e.g. a1, a3, a4, a5, as shown in FIG. 4). Resource set A2 may include four resources (a4, a5, a6, a7), etc. Multiple resource sets (such as A1, A2, A3 . . . ) can be created based on various combinations or subsets of resources a1, a2, a3 . . . aN available at OFDM symbol 410, according to this illustrative example. Thus, a 1 symbol PUCCH may be selected or supported from a set of resources available at symbol 410, for example. For example, resource set A1 of resources (a1, a3, a4, a5) may be selected from a plurality of PUCH resource sets (e.g., A1, A2, A3, . . . ), and then resource a3 may be selected by a UE from the resource set A1 and used for a 1 symbol short PUCCH, as an illustrative example. Similarly, in the second slot, resources are located within the last OFDM symbol 422 and the second to last OFDM symbol 420 of the second slot. Similar sets can be created from all available resources (b1, b2, b3, b4, b5, b6, b7, . . . ) within the second to last OFDM symbol 420 (thus, allowing different resources sets B1, B2, B3 to be created, based on subsets of resources provided within OFDM symbol 420).

### Example B

Resources are located within the last OFDM symbol 422 and the second to last OFDM symbol 420 of the slot. A resource set may be provided that may include a resource from each of the two OFDM symbols 420, 422. Thus, for example, a resource set B1 (e.g., including resources a2, a3, b1, b2) may include one or more resources (a2, a3) from the OFDM symbol 422 and one or more resources (e.g., b1, b2) from OFDM symbol 420. Similarly, other resource sets may be provided that each include (e.g., in various combinations) one or more resources from each of OFDM symbols 420, 422.

### Example C

Resources are located within the last OFDM symbol 422 and the second to last OFDM symbol 420 of the slot. In this type of resource set, at least one resource entry of the resource set includes a resource from two OFDM symbols 420, 422. Thus, for example, for a resource set C1 (b3+a3, b2+a2, b1, a1), two entries (e.g., entries b3+a3, and b2+a2) of the resource set contain resources in both the last OFDM symbol 422 and the second to last OFDM symbol 420 of the slot. For example, when the first entry (b3+a3) of resource set C1 is selected by ARI, then this entry, including a resource from both symbols 420, 422, will be occupied or used by UE for PUCCH when selected by ARI (acknowledgement resource indicator). Thus, different examples resource set types, e.g., A, B, and C resource set types, may be applied by a BS for a UE(s) in different situations or scenarios.

A number of the PUCCH resource configuration parameters may be fixed. Such parameters that may have fixed values, may include, e.g., PUCCH format (e.g., either long or short, some PUCCH resource sets contain long PUCCH resources, and other PUCCH resource sets contain short PUCCH resources), PUCCH duration in symbols (e.g., long PUCCH can have variable length, e.g., 4-14 symbols, and short PUCCH can be 1-2 symbols); number of PRBs allocated (per frequency hop or frequency cluster), space between the frequency clusters or frequency hops, location of PUCCH region relative to, e.g., synchronization channel, carrier edge, etc.

Example Techniques to Select an Uplink Control Channel Resource Set

According to an example implementation, a number of different techniques may be used by a UE to select a set of uplink control channel (e.g., PUCCH) resources out of a plurality of predetermined uplink control channel (e.g., PUCCH) resource sets. For example, a UE may determine or select a set of uplink control channel resources out of a plurality of predetermined sets of uplink control channel resources by either (by way of illustrative examples):

1) The UE may receive, during a random access procedure, such as within a random access response (random access message 2) received from a BS, an uplink control channel (e.g., PUCCH) resource set index that identifies a resource set of uplink control channel (e.g., PUCCH) resources that the user device/UE should use. Or,

2) The PUCCH resource set indexes, for the plurality of predetermined uplink control channel resource sets, may be cell specific and may be included in system information broadcast by the BS (e.g., the PUCCH resource set index(es) may be indicated via system information (such as system information block/SIB) via broadcast channel or shared channel. For example, the system information may include resource set indexes for all of the predetermined uplink control channel resource sets (e.g., all four of the resource sets). Or, for example, the system information may indicate a PUCCH resource set index of a first PUCCH resource set, and a number of PUCCH resource sets (e.g., allowing the UE to determine all resource set indexes based on this information). Next, the UE may determine a selected uplink control channel resource set (from the plurality of predetermined resource sets) based on a UE identifier. For example, the UE may receive, via a downlink grant or other resource grant, an identifier (e.g., radio network temporary identifier or RNTI) associated with the UE/user device, and then the UE may select or determine (e.g., based on the identifier or RNTI) a resource set of the plurality of predetermined sets of uplink control channel (e.g., PUCCH) resource sets, to be used by the user device/UE. For example, the two (or other number of) least significant bits (LSBs) of the RNTI (or other UE identifier) may be used to identify a PUCCH resource set. For example, if 4 PUCCH resource sets are indicated via system information, the UE may use 2 LSBs of RNTI or other identifier to determine the associated PUCCH resource set. Thus, for example, one or more bits of the RNTI or other UE identifier may correspond to or may be used to identify the resource set index of a selected uplink control channel (e.g., PUCCH) resource set. Other techniques may also be used to select an uplink control channel (e.g., PUCCH) resource set out of a plurality of predetermined or possible uplink control channel resource sets. In this manner, a pseudo random technique may be used for a resource set to be selected by the UE, and the pseudo-random nature of this selection may provide a balance for multiple UEs among the plurality of uplink control channel (e.g., PUCCH) resource sets.

Example Techniques to Select a Resource within a Resource Set:

According to an example implementation, a specific resource (or resource entry) within the determined or selected uplink control channel (PUCCH) resource set may be selected by the UE. For example, the UE may receive an indicator, such as an acknowledgement resource indicator (ARI), e.g., provided in a downlink grant from a BS (which may be used to identify or select a resource or resource index within the selected resource set). The UE may select a resource within the determined/selected resource set based on the ARI, for example. Then, for example, the UE may transmit uplink control information, e.g., a HARQ-ACK or other UCI, on the selected PUCCH resource of the selected/determined PUCCH resource set. Other example techniques may be used to select a resource from a resource set.

### ADDITIONAL INFORMATION AND EXAMPLES

According to an example, when a UE determines the logical PUCCH resource indexes, these indexes may determine or indicate one or more parameters, such as, e.g., possible cyclic shift and/or orthogonal cover code (OCC) index for both data (UCI) and reference signal symbols (DMRS), as well as used PRBs (physical resource blocks) relative to the PUCCH region starting point. A resource index may define certain properties of PUCCH resources. So if resource indexes are 0, 1, 2, 3—each index may indicate a resource having a different cyclic shift and a different OCC. This may provide a mechanism to separate resources, via code division multiplexing. Also, the UE may use other system information made available to UE, e.g., data channel sub-carrier spacing, CP length, used spreading and reference signal sequences, frequency domain location of PUCCH region starting point based on synchronization channel, carrier bandwidth, carrier edge location, etc. Thus, when we the UE is determining PUCCH resources for transmission, the UE may receive some parameters via system information, for example.

According to an example implementation, multiple PUCCH resource sets may be defined separately for long PUCCH and short PUCCH. Following this example implementation, the gNB (5G/NR BS) may indicate the used PUCCH resource sets separately for long PUCCH and short PUCCH. For example, different resource set indexes may be used for long PUCCH and short PUCCH, e.g., where it is known/predetermined or where it is indicated by BS, for example, that certain resource set indexes are for long PUCCH (e.g., resource sets 1−N), and other resource set indexes (e.g., resource sets N+1−M) are for short PUCCH. Thus, for example, certain resource set indexes are associated with long PUCCH, and other resource set indexes are associated with short PUCCH.

Another option or example implementation is to have both long PUCCH and short PUCCH defined within each PUCCH resource set. Thus, in this example implementation: each PUCCH resource set contains the necessary resource indexes for both long PUCCH and short PUCCH; and the gNB/BS indicates the used PUCCH resource set jointly for both long PUCCH and short PUCCH. Regardless of the configuration option used, the UE may derive the actual PUCCH resource type based on determined/indicated slot type (derived from downlink control information or higher layer configuration) and/or indicated PUCCH resource type derived from downlink control information. Thus, following this example or option, a resource within a resource set may be selected based on slot type, either, for example: UL only slot, bidirectional UL slot when most of the resources are used for UL; bidirectional DL slot when most of the resources are allocated for DL. Slot type may be signaled by BS to UE via DCI common to all UEs, for example. For example: UE would use a short PUCCH resource from a resource set if slot type is either: bidirectional DL slot; and UE would use a long PUCCH resource from a resource set if slot type is either UL only slot or bidirectional UL slot. In general, for this illustrative example implementation, a PUCCH type may depend on slot type indication.

According to one or more example implementations, multiple PUCCH resource sets available for UEs, which have not yet received the RRC configuration may be pre-defined, e.g., by a specification, and may be known by the UE and BS, for example. The specification may contain different PUCCH resource sets optimized for different scenarios, such as below 6 GHz (e.g. digital beamforming architecture), and above 6 GHz (e.g. hybrid beamforming architecture).

Various example implementations may have one or more advantages, such as for example one or more of:

These techniques may present a flexible solution to configure PUCCH resource set when the UE has not yet received the UE-specific RRC configuration.

One or more example implementations may be fully scalable in terms of UEs without UE-specific RRC configuration

Example implementation(s) may support both long PUCCH and short PUCCH.

Example implementation(s) may support resource configuration optimized for RF beamforming and coverage boost.

In at least some cases, signaling burden may typically be relatively low/small.

### Example 1

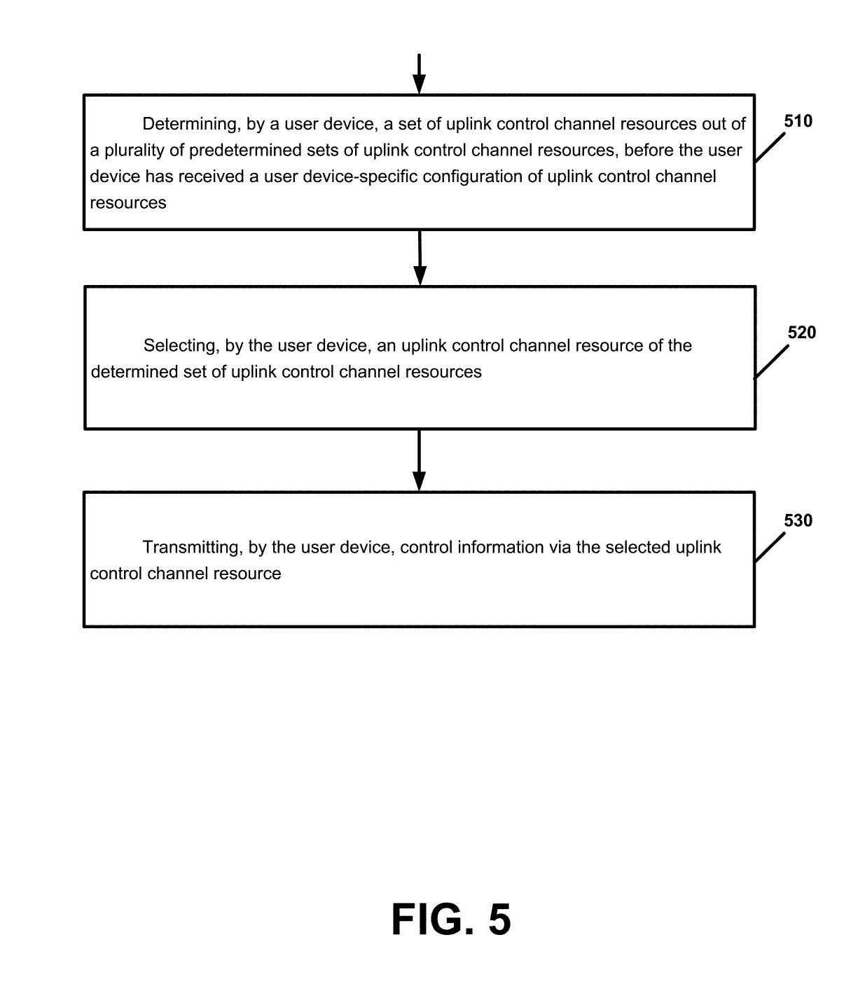

FIG. 5 is a flow chart illustrating operation of a user device according to an example implementation. Operation 510 includes determining, by a user device, a set of uplink control channel resources out of a plurality of predetermined sets of uplink control channel resources, before the user device has received a user device-specific configuration of uplink control channel resources. Operation 520 includes selecting, by the user device, an uplink control channel resource of the determined set of uplink control channel resources. And, operation 530 includes transmitting, by the user device, control information via the selected uplink control channel resource.

### Example 2

According to an example implementation of the method of example 1, wherein the user device-specific configuration of uplink control channel resources comprises a user device-specific configuration of a set of uplink control channel resources.

### Example 3

According to an example implementation of the method of any of examples 1-2, wherein the determining comprises: receiving, by the user device during a random access procedure with a base station, an uplink control channel resource set index that identifies the set of uplink control channel resources out of the plurality of predetermined sets of uplink control channel resources.

### Example 4

According to an example implementation of the method of any of examples 1-3, wherein the determining comprises: receiving, by the user device via system information, information describing a plurality of uplink control channel resource set indexes, each uplink control channel resource set index identifying a predetermined uplink control channel resource set; receiving, by the user device via a resource grant, an identifier associated with the user device; and selecting, based on at least a portion of the identifier, an uplink control channel resource set of the plurality of predetermined uplink control channel resource sets.

### Example 5

According to an example implementation of the method of any of examples 1-4, wherein the receiving information describing a plurality of uplink control channel resource set indexes comprises at least one of the following: receiving a first uplink control channel resource set index and a number of uplink control channel resource set indexes; and receiving the plurality of uplink control channel resource set indexes.

### Example 6

According to an example implementation of the method of any of examples 1-5, wherein receiving an identifier comprises: receiving a radio network temporary identifier (RNTI) associated with the user device via a downlink grant; and wherein the selecting an uplink control channel resource set comprises selecting, based on at least a portion of the radio network temporary identifier, an uplink control channel resource set of the plurality of uplink control channel resource sets.

### Example 7

According to an example implementation of the method of any of examples 1-6, wherein the selecting an uplink control channel resource set comprises: selecting, based on two least significant bits (LSBs) of the radio network temporary identifier, an uplink control channel resource set of the plurality of uplink control channel resource sets.

### Example 8

According to an example implementation of the method of any of examples 1-7, wherein the selecting an uplink control channel resource of the determined set of uplink control channel resources comprises: receiving, by the user device, an acknowledgement resource indicator (ARI) provided in a downlink grant; and selecting, by the user device based on the acknowledgement resource indicator, an uplink control channel resource of the determined set of uplink control channel resources.

### Example 9

According to an example implementation of the method of any of examples 1-8, wherein the plurality of predetermined sets of uplink control channel resources comprises a plurality of predetermined sets of physical uplink control channel (PUCCH) resources.

### Example 10

According to an example implementation of the method of any of examples 1-9, wherein control channel resources on each of the plurality of predetermined sets of uplink control channel resources correspond to at least one of short PUCCH resources and long PUCCH resources.

### Example 11

According to an example implementation of the method of any of examples 1-10, wherein at least one control channel resource set of the plurality of predetermined sets of uplink control channel resources comprises PUCCH resources from both short PUCCH and long PUCCH.

### Example 12

According to an example implementation of the method of any of examples 1-11, wherein at least one control channel resource set of the plurality of predetermined sets of uplink control channel resources comprises PUCCH resources mapped to at least two different OFDM (orthogonal frequency division multiplexing) symbols of the slot.

### Example 13

According to an example implementation of the method of any of examples 1-12, wherein the plurality of predetermined sets of uplink control channel resources comprises physical uplink control channel (PUCCH) resources with resource or resource set specific HARQ-ACK (hybrid automatic repeat request Acknowledgement) timing relationship with respect to physical downlink shared channel (PDSCH) timing.

### Example 14

According to an example implementation of the method of any of examples 1-13, wherein each of the plurality of predetermined sets of uplink control channel resources includes a consecutive set of uplink control channel resources.

### Example 15

According to an example implementation of the method of any of examples 1-14, wherein resources of at least two consecutive sets of the plurality of predetermined sets of uplink control channel resources at least partially overlap.

### Example 16

According to an example implementation of the method of any of examples 1-15, wherein the determining comprises determining, by the user device based on system information received by the user device indicating a physical uplink control channel (PUCCH) resource set index, a set of PUCCH resources before the user device has received a user device-specific configuration of uplink control channel resources; and wherein the selecting comprises selecting, by the user device based on a resource indicator received by the user device, a PUCCH resource of the determined set of PUCCH resources.

### Example 17

An apparatus comprising means for performing the method any of examples 1-16.

### Example 18

An apparatus comprising at least one processor and at least one memory including computer instructions, when executed by the at least one processor, cause the apparatus to perform the method of any of examples 1-16.

### Example 19

A computer program product includes a computer-readable storage medium and storing executable code that, when executed by at least one data processing apparatus, is configured to cause the at least one data processing apparatus to perform a method comprising: determining, by a user device, a set of uplink control channel resources out of a plurality of predetermined sets of uplink control channel resources, before the user device has received a user device-specific configuration of uplink control channel resources; selecting, by the user device, an uplink control channel resource of the determined set of uplink control channel resources; and transmitting, by the user device, control information via the selected uplink control channel resource.

### Example 20

An apparatus comprising: means for determining, by a user device, a set of uplink control channel resources out of a plurality of predetermined sets of uplink control channel resources, before the user device has received a user device-specific configuration of uplink control channel resources; means for selecting, by the user device, an uplink control channel resource of the determined set of uplink control channel resources; and means for transmitting, by the user device, control information via the selected uplink control channel resource.

### Example 21

An apparatus comprising at least one processor and at least one memory including computer instructions, when executed by the at least one processor, cause the apparatus to: determine, by a user device, a set of uplink control channel resources out of a plurality of predetermined sets of uplink control channel resources, before the user device has received a user device-specific configuration of uplink control channel resources; select, by the user device, an uplink control channel resource of the determined set of uplink control channel resources; and transmit, by the user device, control information via the selected uplink control channel resource.

### Example 22

The apparatus of example 21 wherein the user device-specific configuration of uplink control channel resources comprises a user device-specific configuration of a set of uplink control channel resources.

### Example 23

The apparatus of any of examples 21-22 wherein causing the apparatus to determine comprises causing the apparatus to: receive, by the user device during a random access procedure with a base station, an uplink control channel resource set index that identifies the set of uplink control channel resources out of the plurality of predetermined sets of uplink control channel resources.

### Example 24

The apparatus of any of examples 21-23 wherein causing the apparatus to determine comprises causing the apparatus to: receive, by the user device via system information, information describing a plurality of uplink control channel resource set indexes, each uplink control channel resource set index identifying a predetermined uplink control channel resource set; receive, by the user device via a resource grant, an identifier associated with the user device; and select, based on at least a portion of the identifier, an uplink control channel resource set of the plurality of predetermined uplink control channel resource sets.

### Example 25

The apparatus of any of examples 21-24 wherein causing the apparatus to receive information describing a plurality of uplink control channel resource set indexes comprises causing the apparatus to perform at least one of the following: receive a first uplink control channel resource set index and a number of uplink control channel resource set indexes; and receive the plurality of uplink control channel resource set indexes.

### Example 26

The apparatus of any of examples 21-25 wherein causing the apparatus to receive an identifier comprises causing the apparatus to: receive a radio network temporary identifier (RNTI) associated with the user device via a downlink grant; and wherein causing the apparatus to select an uplink control channel resource set comprises causing the apparatus to select, based on at least a portion of the radio network temporary identifier, an uplink control channel resource set of the plurality of uplink control channel resource sets.

### Example 27

The apparatus of any of examples 21-26 wherein causing the apparatus to select an uplink control channel resource set comprises causing the apparatus to: select, based on two least significant bits (LSBs) of the radio network temporary identifier, an uplink control channel resource set of the plurality of uplink control channel resource sets.

### Example 28

The apparatus of any of examples 21-27 wherein causing the apparatus to select an uplink control channel resource of the determined set of uplink control channel resources comprises causing the apparatus to: receive, by the user device, an acknowledgement resource indicator (ARI) provided in a downlink grant; and select, by the user device based on the acknowledgement resource indicator, an uplink control channel resource of the determined set of uplink control channel resources.

### Example 29

The apparatus of any of examples 21-28 wherein the plurality of predetermined sets of uplink control channel resources comprises a plurality of predetermined sets of physical uplink control channel (PUCCH) resources.

### Example 30

The apparatus of any of examples 21-29 wherein control channel resources on each of the plurality of predetermined sets of uplink control channel resources correspond to at least one of short PUCCH resources and long PUCCH resources.

### Example 31

The apparatus of any of examples 21-30 wherein at least one control channel resource set of the plurality of predetermined sets of uplink control channel resources comprises PUCCH resources from both short PUCCH and long PUCCH.

### Example 32

The apparatus of any of examples 21-31 wherein at least one control channel resource set of the plurality of predetermined sets of uplink control channel resources comprises PUCCH resources mapped to at least two different OFDM (orthogonal frequency division multiplexing) symbols of the slot.

### Example 33

The apparatus of any of examples 21-32 wherein the plurality of predetermined sets of uplink control channel resources comprises physical uplink control channel (PUCCH) resources with resource or resource set specific HARQ-ACK (hybrid automatic repeat request Acknowledgement) timing relationship with respect to physical downlink shared channel (PDSCH) timing.

### Example 34

The apparatus of any of examples 21-33 wherein each of the plurality of predetermined sets of uplink control channel resources includes a consecutive set of uplink control channel resources.

### Example 35

The apparatus of any of examples 21-34 wherein resources of at least two consecutive sets of the plurality of predetermined sets of uplink control channel resources at least partially overlap.

### Example 36

The apparatus of any of examples 21-35:

wherein causing the apparatus to determine comprises causing the apparatus to determine, by the user device based on system information received by the user device indicating a physical uplink control channel (PUCCH) resource set index, a set of PUCCH resources before the user device has received a user device-specific configuration of uplink control channel resources; and

wherein causing the apparatus to select comprises causing the apparatus to select, by the user device based on a resource indicator received by the user device, a PUCCH resource of the determined set of PUCCH resources.

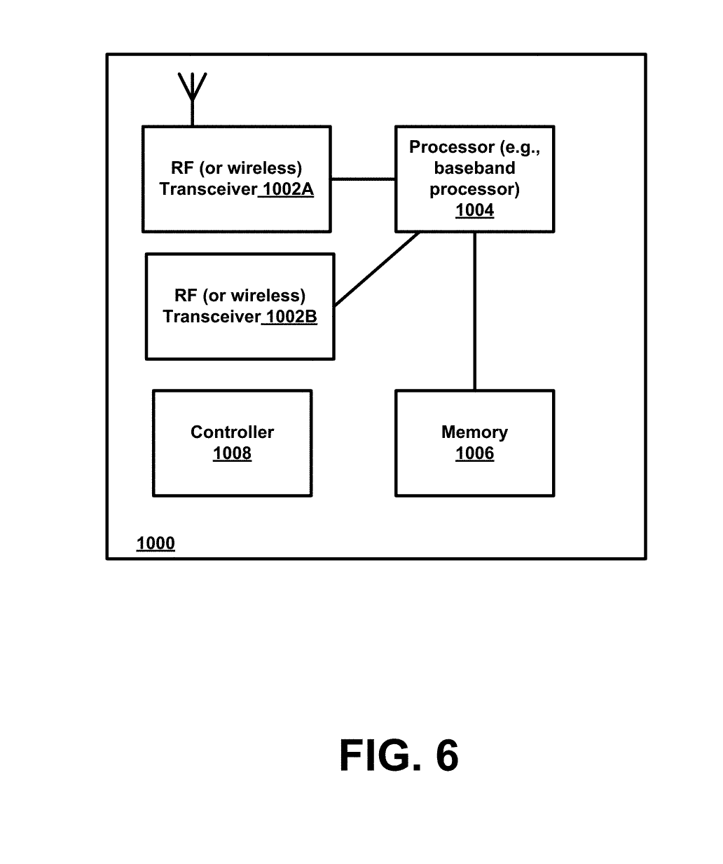

FIG. 6 is a block diagram of a wireless station (e.g., AP, BS, eNB, UE or user device) 1000 according to an example implementation. The wireless station 1000 may include, for example, one or two RF (radio frequency) or wireless transceivers 1002A, 1002B, where each wireless transceiver includes a transmitter to transmit signals and a receiver to receive signals. The wireless station also includes a processor or control unit/entity (controller) 1004 to execute instructions or software and control transmission and receptions of signals, and a memory 1006 to store data and/or instructions.

Processor 1004 may also make decisions or determinations, generate frames, packets or messages for transmission, decode received frames or messages for further processing, and other tasks or functions described herein. Processor 1004, which may be a baseband processor, for example, may generate messages, packets, frames or other signals for transmission via wireless transceiver 1002 (1002A or 1002B). Processor 1004 may control transmission of signals or messages over a wireless network, and may control the reception of signals or messages, etc., via a wireless network (e.g., after being down-converted by wireless transceiver 1002, for example). Processor 1004 may be programmable and capable of executing software or other instructions stored in memory or on other computer media to perform the various tasks and functions described above, such as one or more of the tasks or methods described above. Processor 1004 may be (or may include), for example, hardware, programmable logic, a programmable processor that executes software or firmware, and/or any combination of these. Using other terminology, processor 1004 and transceiver 1002 together may be considered as a wireless transmitter/receiver system, for example.

In addition, referring to FIG. 6, a controller (or processor) 1008 may execute software and instructions, and may provide overall control for the station 1000, and may provide control for other systems not shown in FIG. 6, such as controlling input/output devices (e.g., display, keypad), and/or may execute software for one or more applications that may be provided on wireless station 1000, such as, for example, an email program, audio/video applications, a word processor, a Voice over IP application, or other application or software.

In addition, a storage medium may be provided that includes stored instructions, which when executed by a controller or processor may result in the processor 1004, or other controller or processor, performing one or more of the functions or tasks described above.

According to another example implementation, RF or wireless transceiver(s) 1002A/1002B may receive signals or data and/or transmit or send signals or data. Processor 1004 (and possibly transceivers 1002A/1002B) may control the RF or wireless transceiver 1002A or 1002B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.
HARQ Hybrid Automatic Repeat reQuest
(CA)ZAC (Constant Amplitude) Zero AutoCorrelation
ACK Acknowledgement
BW Bandwidth
gNB NR/5G Node B
CM Cubic metric
CP Cyclic Prefix
CS Cyclic Shift
CSI Channel state information
DCI Downlink Control Information
DFT-S-OFDM Discrete Fourier Transform Spread OFDM
DL Downlink
eMBB Enhanced Mobile Broadband
GP Guard Period
LTE Long Term Evolution
NR New Radio (5G)
OCC Orthogonal Cover Code
OFDM Orthogonal Frequency Division Multiplexing
PAPR Peak-to-average power ratio
PDCCH Physical Downlink Control Channel
PDSCH Physical Downlink Shared Channel
PRB Physical Resource Block
PUCCH Physical Uplink Control Channel
PUSCH Physical Uplink Shared Channel
QPSK Quadrature Phase Shift Keying
RF Radio Frequency
RS Reference Signal
SR Scheduling Request
SRS Sounding Reference Signal
TDD Time Division Duplexing
TDM Time Division Multiplexing
UCI Uplink Control Information
UE User Equipment
UL Uplink
URLLC Ultra-Reliable and Low-Latency Communications

What is claimed is:

1. A method comprising:
determining, by a user device, a set of uplink control channel resources out of a plurality of predetermined sets of uplink control channel resources, before the user device has received a user device-specific configuration of uplink control channel resources;
selecting, by the user device, an uplink control channel resource of the determined set of uplink control channel resources; and
transmitting, by the user device, control information via the selected uplink control channel resource.

2. The method of claim 1 wherein the user device-specific configuration of uplink control channel resources comprises a user device-specific configuration of a set of uplink control channel resources.

3. The method of claim 1 wherein the determining comprises:
receiving, by the user device during a random access procedure with a base station, an uplink control channel resource set index that identifies the set of uplink control channel resources out of the plurality of predetermined sets of uplink control channel resources.

4. The method of any of claim 1 wherein the determining comprises:
receiving, by the user device via system information, information describing a plurality of uplink control channel resource set indexes, each uplink control channel resource set index identifying a predetermined uplink control channel resource set;
receiving, by the user device via a resource grant, an identifier associated with the user device;
selecting, based on at least a portion of the identifier, an uplink control channel resource set of the plurality of predetermined uplink control channel resource sets.

5. The method of claim 4 wherein the receiving information describing a plurality of uplink control channel resource set indexes comprises at least one of the following:
receiving a first uplink control channel resource set index and a number of uplink control channel resource set indexes; and
receiving the plurality of uplink control channel resource set indexes.

6. The method of claim 4 wherein receiving an identifier comprises:
receiving a radio network temporary identifier (RNTI) associated with the user device via a downlink grant; and
wherein the selecting an uplink control channel resource set comprises selecting, based on at least a portion of the radio network temporary identifier, an uplink control channel resource set of the plurality of uplink control channel resource sets.

7. The method of claim 6 wherein the selecting an uplink control channel resource set comprises:
selecting, based on two least significant bits (LSBs) of the radio network temporary identifier, an uplink control channel resource set of the plurality of uplink control channel resource sets.

8. The method of claim 1 wherein the selecting an uplink control channel resource of the determined set of uplink control channel resources comprises:
receiving, by the user device, an acknowledgement resource indicator (ARI) provided in a downlink grant; and
selecting, by the user device based on the acknowledgement resource indicator, an uplink control channel resource of the determined set of uplink control channel resources.

9. The method of claim 1 wherein the plurality of predetermined sets of uplink control channel resources comprises a plurality of predetermined sets of physical uplink control channel (PUCCH) resources.

10. The method of claim 1 wherein control channel resources on each of the plurality of predetermined sets of uplink control channel resources correspond to at least one of short PUCCH resources and long PUCCH resources.

11. The method of claim 1 wherein at least one control channel resource set of the plurality of predetermined sets of uplink control channel resources comprises PUCCH resources from both short PUCCH and long PUCCH.

12. The method of claim 1 wherein at least one control channel resource set of the plurality of predetermined sets of uplink control channel resources comprises PUCCH resources mapped to at least two different OFDM (orthogonal frequency division multiplexing) symbols of the slot.

13. The method of claim 1 wherein the plurality of predetermined sets of uplink control channel resources comprises physical uplink control channel (PUCCH) resources with resource or resource set specific HARQ-ACK (hybrid automatic repeat request Acknowledgement) timing relationship with respect to physical downlink shared channel (PDSCH) timing.

14. The method of claim 1 wherein each of the plurality of predetermined sets of uplink control channel resources includes a consecutive set of uplink control channel resources.

15. The method of claim 1 wherein resources of at least two consecutive sets of the plurality of predetermined sets of uplink control channel resources at least partially overlap.

16. The method of claim 1:
wherein the determining comprises determining, by the user device based on system information received by the user device indicating a physical uplink control channel (PUCCH) resource set index, a set of PUCCH resources before the user device has received a user device-specific configuration of uplink control channel resources; and
wherein the selecting comprises selecting, by the user device based on a resource indicator received by the user device, a PUCCH resource of the determined set of PUCCH resources.

17. A computer program product includes a computer-readable storage medium and storing executable code that, when executed by at least one data processing apparatus, is configured to cause the at least one data processing apparatus to perform a method comprising:
determining, by a user device, a set of uplink control channel resources out of a plurality of predetermined sets of uplink control channel resources, before the user device has received a user device-specific configuration of uplink control channel resources;
selecting, by the user device, an uplink control channel resource of the determined set of uplink control channel resources; and
transmitting, by the user device, control information via the selected uplink control channel resource.

18. An apparatus comprising at least one processor and at least one memory including computer instructions, when executed by the at least one processor, cause the apparatus to:
determine, by a user device, a set of uplink control channel resources out of a plurality of predetermined sets of uplink control channel resources, before the user device has received a user device-specific configuration of uplink control channel resources;
select, by the user device, an uplink control channel resource of the determined set of uplink control channel resources; and
transmit, by the user device, control information via the selected uplink control channel resource.

19. The apparatus of claim 18 wherein the user device-specific configuration of uplink control channel resources comprises a user device-specific configuration of a set of uplink control channel resources.

20. The apparatus of claim 18 wherein causing the apparatus to determine comprises causing the apparatus to:
receive, by the user device during a random access procedure with a base station, an uplink control channel resource set index that identifies the set of uplink control channel resources out of the plurality of predetermined sets of uplink control channel resources.

21. The apparatus of any claim 18 wherein causing the apparatus to determine comprises causing the apparatus to:
receive, by the user device via system information, information describing a plurality of uplink control channel resource set indexes, each uplink control channel resource set index identifying a predetermined uplink control channel resource set;
receive, by the user device via a resource grant, an identifier associated with the user device; and
select, based on at least a portion of the identifier, an uplink control channel resource set of the plurality of predetermined uplink control channel resource sets.

22. The apparatus of claim 21 wherein causing the apparatus to receive information describing a plurality of uplink control channel resource set indexes comprises causing the apparatus to perform at least one of the following:
receive a first uplink control channel resource set index and a number of uplink control channel resource set indexes; and
receive the plurality of uplink control channel resource set indexes.

23. The apparatus of any claim 21 wherein causing the apparatus to receive an identifier comprises causing the apparatus to:
receive a radio network temporary identifier (RNTI) associated with the user device via a downlink grant; and
wherein causing the apparatus to select an uplink control channel resource set comprises causing the apparatus to select, based on at least a portion of the radio network temporary identifier, an uplink control channel resource set of the plurality of uplink control channel resource sets.

24. The apparatus of claim 23 wherein causing the apparatus to select an uplink control channel resource set comprises causing the apparatus to:
select, based on two least significant bits (LSBs) of the radio network temporary identifier, an uplink control channel resource set of the plurality of uplink control channel resource sets.

25. The apparatus of claim 18 wherein causing the apparatus to select an uplink control channel resource of the determined set of uplink control channel resources comprises causing the apparatus to:
receive, by the user device, an acknowledgement resource indicator (ARI) provided in a downlink grant; and
select, by the user device based on the acknowledgement resource indicator, an uplink control channel resource of the determined set of uplink control channel resources.

26. The apparatus of claim 18 wherein control channel resources on each of the plurality of predetermined sets of uplink control channel resources correspond to at least one of short PUCCH resources and long PUCCH resources.

27. The apparatus of claim 18 wherein at least one control channel resource set of the plurality of predetermined sets of uplink control channel resources comprises PUCCH resources from both short PUCCH and long PUCCH.

28. The apparatus of claim 18 wherein at least one control channel resource set of the plurality of predetermined sets of uplink control channel resources comprises PUCCH resources mapped to at least two different OFDM (orthogonal frequency division multiplexing) symbols of the slot.

29. The apparatus of claim 18 wherein the plurality of predetermined sets of uplink control channel resources comprises physical uplink control channel (PUCCH) resources with resource or resource set specific HARQ-ACK (hybrid automatic repeat request Acknowledgement) timing relationship with respect to physical downlink shared channel (PDSCH) timing.

30. The apparatus of claim 18 wherein resources of at least two consecutive sets of the plurality of predetermined sets of uplink control channel resources at least partially overlap.

31. The apparatus of claim 18:
wherein causing the apparatus to determine comprises causing the apparatus to determine, by the user device based on system information received by the user device indicating a physical uplink control channel (PUCCH) resource set index, a set of PUCCH resources before the user device has received a user device-specific configuration of uplink control channel resources; and
wherein causing the apparatus to select comprises causing the apparatus to select, by the user device based on a resource indicator received by the user device, a PUCCH resource of the determined set of PUCCH resources.
